(19) United States
(12) Patent Application Publication
(10) Pub. No.: US 2025/0284072 A1
(43) Pub. Date: Sep. 11, 2025

(54) MULTIPLEXED SINGLE-PHOTON GENERATOR AND ASSOCIATED METHODS

(71) Applicant: memQ, Inc., Chicago, IL (US)

(72) Inventors: Sean Sullivan, Chicago, IL (US); Skylar Deckoff-Jones, Chicago, IL (US); Manish Kumar Singh, Chicago, IL (US); Robert Pettit, Chicago, IL (US)

(21) Appl. No.: 19/076,296

(22) Filed: Mar. 11, 2025

Related U.S. Application Data
(60) Provisional application No. 63/563,787, filed on Mar. 11, 2024.

(51) Int. Cl. G02B 6/42; G02B 6/293; G02F 1/31

(52) U.S. Cl. CPC G02B 6/4206; G02B 6/29335; G02B 6/2938; G02B 6/4215; G02F 1/31

(57) ABSTRACT

A multiplexed single-photon generator includes a plurality of single-photon sources, an optical switching network controllable to couple pump light into any one of the single-photon sources, and a bus waveguide optical coupled to all of the single-photon sources. Each single-photon source includes a quantum emitter coupled to an optical cavity. All of the single photons emitted by all of the single-photon sources propagate along the bus waveguide. The single-photon generator may be time-multiplexed in which only one of the single-photon sources is pumped at any time. In this case, the single photons form a temporal sequence with little or no temporal overlap. As an alternative to time multiplexing, the single-photon generator may be frequency-multiplexed such that each single-photon source emits single photons that are distinguishable from the other emitted single photons based on optical frequency.

### RELATED APPLICATIONS

This application claims priority to U.S. Provisional Patent Application No. 63/563,787, filed on Mar. 11, 2024, which is incorporated herein by reference in its entirety.

### BACKGROUND

A single-photon source is a light source that emits single particles of light (i.e., single-photon Fock states) at specific wavelengths and specified times.

### SUMMARY

Single-photon sources are important tools for many fields of science and engineering, including quantum optics, cryptography (e.g., quantum key distribution), quantum computing, and photonics. Also known as single-photon emitters, single-photon sources emit single photons that may be used as units of quantum information or as probes for various quantum sensors. For example, single-photon sources are frequently used in quantum optics to study the fundamental properties of light and how photons interact with matter. Single-photon sources also allow researchers to observe and manipulate individual photons, essential for studying phenomena like quantum entanglement, boson sampling, and quantum superposition. In another example, single-photon sources may be used to generate photonic qubits for quantum computing. In yet another example, single-photon sources may be used for high-speed, low-power optical communication systems. Single-photon sources may also be used for sensing applications, such as biomedical imaging and environmental monitoring.

The present embodiments include a multiplexed single-photon generator that combines multiple single-photon sources into a single platform. The single-photon generator includes an optical switching network that couples pump light into any one of the single-photon sources. The single-photon generator also includes a bus waveguide that is coupled to all of the single-photon sources so that all of the single photons emitted by all of the single-photon sources propagate in the same direction down the bus waveguide. Advantageously, the resulting stream of single photons has a photon rate (i.e., the number of single photons per unit time) that may be much higher than what any one single-photon source can generate alone. In addition, the single-photon generator may be fabricated using photonic integrated circuit (PIC) technologies, and therefore may be integrated with other photonic and electronic components onto a single chip.

In some embodiments, the single-photon generator is time-multiplexed in that only one of the single-photon sources is pumped at any time. The optical switching network may be controlled such that each single photon emitted does not exhibit any significant temporal overlap with other single photons in the stream. In these embodiments, the single photons may be indistinguishable with regards to frequency, i.e., all of the single-photon sources emit single photons at the same optical frequency. In other embodiments, the single-photon generator is frequency-multiplexed by configuring the single-photon sources to emit single photons at different frequencies. In this case, the single photons emitted by one of the single-photon sources are distinguishable from all other single photons based on optical frequency.

In some embodiments, a multiplexed single-photon generator includes a plurality of single-photon sources. Each of the plurality of single-photon sources includes an optical cavity and a quantum emitter coupled to the optical cavity. The multiplexed single-photon generator further includes an optical switching network controllable to couple pump light into the optical cavity of any one of the plurality of single-photon sources. The multiplexed single-photon generator further includes a bus waveguide coupled to the optical cavity of each of the plurality of single-photon sources.

In some embodiments, a method for single-photon generation includes coupling a first pump pulse into the optical switching network of any multiplexed single-photon generator of the present embodiments. The method further includes controlling the optical switching network to couple the first pump pulse into the optical cavity of a first single-photon source of the plurality of single-photon sources of the multiplexed single-photon generator. The method further includes coupling a first single photon emitted by the quantum emitter of the first single-photon source into the first optical cavity of the first single-photon source. The method further includes coupling a first single photon emitted by the quantum emitter of the first single-photon source into the first optical cavity. The method further includes coupling the first single photon from the first optical cavity into the bus waveguide of the multiplexed single-photon generator.

### BRIEF DESCRIPTION OF THE FIGURES

FIG. 1 is a perspective view of a single-photon source, in embodiments.

FIG. 2 is a side cutaway view of a center portion of the single-photon source of FIG. 1.

FIG. 3 is a top view of a single-photon source that incorporates the single-photon source of FIGS. 1 and 2 into a photonic integrated chip, in embodiments.

FIG. 4 is a top view of a time-multiplexed single-photon generator, in embodiments.

FIG. 5 shows a more detailed view of a single-photon source of the time-multiplexed single-photon generator of FIG. 4.

FIG. 6 illustrates a photon stream generated by the time-multiplexed single-photon generator of FIG. 4.

FIG. 7 is a top view of a frequency-multiplexed single-photon generator, in embodiments.

### DETAILED DESCRIPTION

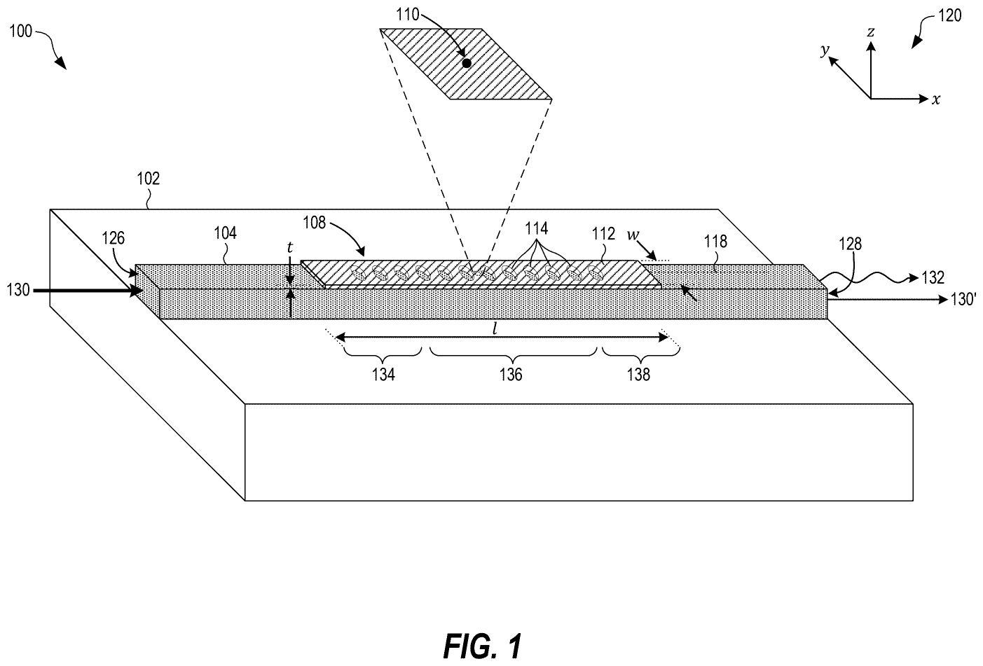

FIG. 1 is a perspective view of a single-photon source 100, in accordance with some of the present embodiments. The single-photon source 100 includes an optical waveguide 104 that guides pump light 130 coupled into the waveguide 104 via an input face 126. For clarity herein, the single-photon source 100 is oriented such that the waveguide 104 guides the pump light 130 in the +x direction of a right-handed Cartesian coordinate system 120. The single-photon source 100 may also include a substrate 102 on which the waveguide 104 is positioned.

The single-photon source 100 includes a photonic crystal cavity 108 located adjacent to the optical waveguide 104. The cavity 108 is created from an array of elliptical holes 114 formed in an optical thin film 112 that is deposited on top of (i.e., in the +z direction) the optical waveguide 104. While the cavity 108 is shown in FIG. 1 forming an array of twelve holes 114 that are spaced along x, the cavity 108 may form a different number of holes 114. While FIG. 1 shows the holes 114 as being elliptical, the holes 114 may alternatively be circular. The cavity 108 may alternatively be a different type of optical cavity or resonator known in the art.

FIG. 1 shows typical dimensions of the optical thin film 112. In the example of FIG. 1, the thin film 112, and therefore the photonic crystal cavity 108, has the same width w (along y) as the optical waveguide 104. Thus, the thin film 112 fully covers the waveguide 104 along y. The thin film 112 has a length l (along x) that is greater than the width w. The thin film 112 has a thickness t (along z) that is comparable to or less than the wavelength λₚ of the (monochromatic) pump light 130. Typically, the thickness t is less than 1 μm. However, the thin film 112 and cavity 108 may have different dimensions without departing from the scope hereof.

The optical thin film 112 is formed from a solid-state material, such as a crystal. Examples of this solid-state material include, but are not limited to, titanium dioxide (TiO₂), calcium tungstate (CaWO₄), yttrium orthosilicate (Y₂SiO₅), yttrium orthovanadate (YVO₄), yttrium aluminum garnet (Y₃Al₅O₁₂), or any combination thereof. The substrate 102 is also a solid-state material, such as a polycrystalline or single-crystal semiconductor. Examples of the substrate material include, but are not limited to, silicon-on-insulator (SOI), lithium niobate, silicon nitride, aluminum nitride, strontium titanate, or any combination thereof.

The single-photon source 100 also includes at least one quantum emitter 110 that is embedded within the optical thin film 112. The quantum emitter 110 may be an ion, molecule, color center (e.g., a nitrogen-vacancy center in diamond), crystal defect, quantum dot, or other type of quantum system or particle that can emit single photons in response to being optically pumped. In some embodiments, the thin film 112 is a crystal and the quantum emitter 110 is a rare-earth ion (e.g., erbium, ytterbium, neodymium, yttrium, praseodymium, europium, holmium, cerium, thulium, etc.) that substitutionally replaces one of the atoms of the crystal's lattice. The quantum emitter 110 may alternatively be interstitially embedded within the thin film 112 (e.g., trapped in a region between atoms of the crystal lattice).

The quantum emitter 110 is located between two of the holes 114 that are adjacent to each other. In FIG. 1, the quantum emitter 110 is centered (along y) with respect to the optical thin film 112, and therefore the photonic crystal cavity 108. The quantum emitter 110 is also centered (along z) with respect to the thickness t of the thin film 112. However, the quantum emitter 110 need not be perfectly centered along x or y in this manner, as the quantum emitter 110 can still couple to the cavity 108 even when it is not perfectly centered. Also in FIG. 1, the quantum emitter 110 is centered (along x) between two of the holes 114 nearest the center of the cavity 108. However, the quantum emitter 110 need not be centered along x in this manner. Furthermore, the quantum emitter 110 may be located between two other holes 114 that are adjacent to each other.

In some embodiments, the single-photon source 100 includes a plurality of quantum emitters 110 embedded within the optical thin film 112. This plurality of quantum emitters 110 may all be the same type of quantum system (e.g., substitutional erbium ions). Alternatively, the plurality of quantum emitters 110 may include two or more different types of quantum systems (e.g., two different species of substitutional rare-earth ion). In some embodiments, the plurality of quantum emitters 110 has a density within the thin film 112 of 1 part-per-million (ppm) or less.

Pump light 130 propagating along the optical waveguide 104 evanescently couples into the optical thin film 112, where it drives the quantum emitter 110. Specifically, the frequency of the pump light 130 is chosen to excite an internal transition of the quantum emitter 110 (e.g., see FIG. 3). After excitation, the quantum emitter 110 spontaneously emits a single photon 132 that also propagates along the optical waveguide 104 in the +x direction. The single photon 132 exits the waveguide 104 via an output face 128. Also propagating along the waveguide 104 is unabsorbed pump light 130′, which also exits the waveguide 104 via the output face 128.

In general, the quantum emitter 110 is located close enough to the photonic crystal cavity 108 that the photonic crystal cavity 108 modifies the final density of photonic states of the quantum emitter 110 when undergoing spontaneous decay. That is, the photonic crystal cavity 108 both modifies the spontaneous decay rate of the quantum emitter 110 and the spatial distribution of the spontaneous emission via the Purcell effect. Specifically, the photonic crystal cavity 108 has an optical resonance that coincides with the emission frequency of the spontaneous emission, which increases the spontaneous decay rate (i.e., decreases the spontaneous lifetime) and increases the probability that the quantum emitter 110 emits the single photon 132 such that it excites the optical resonance. The single photon 132 is then efficiently coupled from the photonic crystal cavity 108 into the optical waveguide 104. By contrast, the quantum emitter 110, in free space (e.g., in the absence of the photonic crystal cavity 108 or another structure that modifies that final density of photonic states), spontaneously emits uniformly in all directions. In this latter case, most of the spontaneous emission cannot be collected and is therefore wasted. Thus, the photonic crystal cavity 108 improves the efficiency with which the single photon 132 is collected, guided along the waveguide 104, and used for the application at hand.

The use of optical cavities to increase spontaneous decay rate and collection efficiency via the Purcell effect is well-known in the art and not limited to the photonic crystal cavity 108. Rather, any type of optical cavity or photonic structure placed close enough to the quantum emitter 110 to modify its final density of photonic states may be used. To achieve significant Purcell enhancement, the single-photon source 100 operates in the “good emitter” regime (also known as the “bad cavity” regime) in which the spectral width of the spontaneous emission is narrower than the linewidth of the optical resonance. As an example, recent experiments using Er³⁺ emitters in TiO₂ achieved spectral diffusion linewidths in the range of 0.2-0.6 GHz for optical resonances with linewidths in the range of 4-7 GHz [1]. A Purcell enhancement factor Fₚ up to several hundred, or more, can be obtained in practice.

There are several ways that the single-photon source 100 can be controlled to ensure that the optical resonance coincides with the wavelength of the single photon 132. For example, the photonic crystal cavity 108 can be heated to change the size and spacings between the holes 114. This heating may be performed by electrically driving a microheater located on the substrate 102 or otherwise in thermal contact with the cavity 108. Alternatively, a strain can be applied to the cavity 108 (e.g., via a piezoelectric material) to change its refractive index and the length l. Alternatively, the transition frequency of the quantum emitter 110 can be modified via Stark tuning (i.e., applying an external electric field) or Zeeman tuning (i.e., applying an external magnetic field). As an example of Stark tuning, electrodes located near the quantum emitter 110 may be electrically driven to create the external electric field. These electrodes may be located in-plane with the thin film 112, above the thin film 112, or below the thin film 112.

The photonic crystal cavity 108 is a one-dimensional photonic crystal in which each of the elliptical holes 114 has a major axis that is parallel to the y axis and a minor axis that is parallel to the x axis (alternatively, the major axis may be parallel to the x axis with the minor axis parallel to the y axis). The minor axes of the elliptical holes 114 are aligned, thereby forming an optical axis 118 of the cavity 108 that coincides with the propagation direction of light in the optical waveguide 104. The cavity 108 has a first section in which the holes 114 are uniformly spaced (i.e., having a lattice constant that does not change along x) to form a first Bragg mirror 134 that reflects light at the resonant frequency of the cavity 108. Note that this resonant frequency is similar to the frequency of the single photon 132. Similarly, the cavity 108 has a second section in which the holes 114 are also uniformly spaced, thereby forming a second Bragg mirror 138 that reflects light at the resonant frequency. The cavity 108 has a middle section 136 in which the holes 114 are not uniformly spaced along x. The resulting irregularity of the lattice constant creates a defect that can be configured to transmit light at the resonant frequency therethrough. Alternatively, the holes 114 in the middle section 136 may be different sizes to vary the lattice constant along x. This structure of an optically transmissive section located between two mirror sections confines light along x. The elliptical shape of the holes 114 further confines light in the transverse y direction while the step changes in refractive index confines light along the transverse z direction. The result is that the cavity 108 confines light in all three spatial directions.

While FIG. 1 shows the photonic crystal cavity 108 being used in a two-sided transmission configuration in which the pump light 130 couples through the first Bragg mirror 134 and the single photon 132 couples through the second Bragg mirror 138, the photonic crystal cavity 108 may alternatively be used in a one-sided reflection configuration. For example, the second Bragg mirror 138 can be made with more holes than the first Bragg mirror 134 to increase its reflectivity at the resonant frequency. In this case, the second Bragg mirror 138 reflects the single photon 132 into the −x direction, where it will couple through the first Bragg mirror 134 and exit the optical waveguide 104 via the input face 126.

The quantum emitter 110 is located near the center of the photonic crystal cavity 108 such that it spatially overlaps the largest electric field of the cavity's resonant mode. This spatial overlap ensures strong coupling between the quantum emitter 110 and the cavity 108. The middle section 136 can be configured such that longitudinally (i.e., along x), the largest electric field is at the center-most antinode of the resonant mode (i.e., the antinode that occurs between the two center-most holes 114 of the middle section 136). The electric field of the resonant mode is linearly polarized along y. Accordingly, when the quantum emitter 110 has a dipole moment, the coupling strength between the quantum emitter 110 and the cavity 108 will depend on the angle between the dipole moment and the y axis, with the strongest coupling occurring when the dipole moment is aligned along y.

The photonic crystal cavity 108 may be designed, fabricated, and used using techniques known in the art. For example, additional details about how to design the photonic crystal cavity 108 for Er emitters can be found in Refs. [2] and [3].

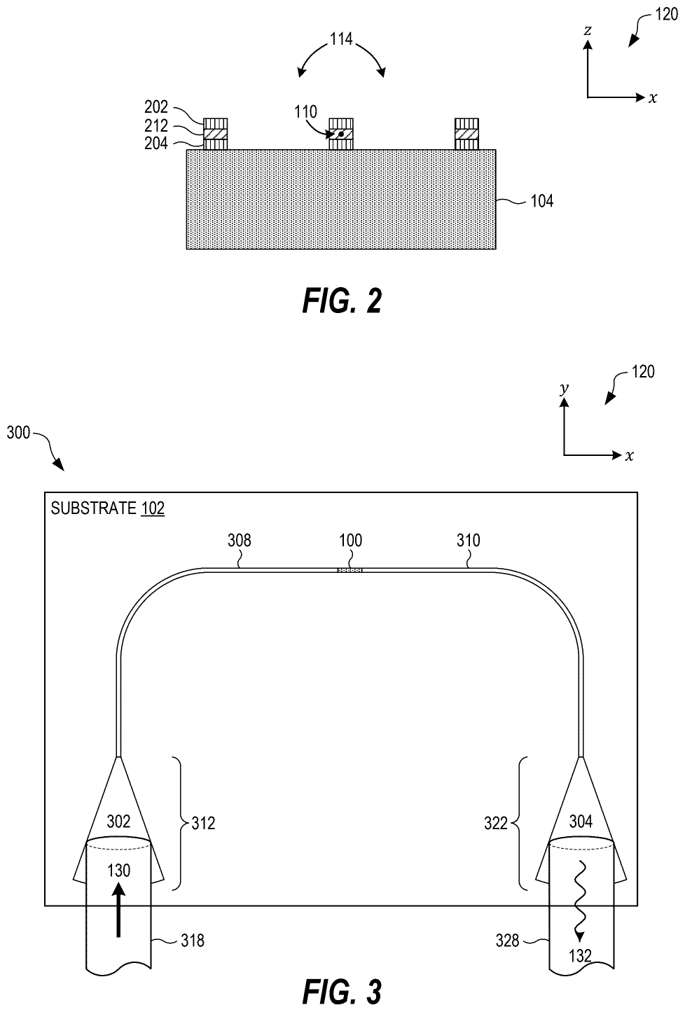

FIG. 2 is a side cutaway view of a center portion of the single-photon source 100 of FIG. 1, taken along the optical axis 118 of the photonic crystal cavity 108. FIG. 2 shows one example of a heterostructure that may be grown and used as the optical thin film 112 of FIG. 1. The quantum emitter 110 is located within a doped layer 212 that is sandwiched between an underlying undoped layer 204 and an overlaying undoped layer 202. The undoped layers 202 and 204 act as buffer layers that protect the quantum emitter 110. The layers 202, 204, and 212 may have the same thickness (as measured along z) or different thicknesses. For example, each of the layers 202, 204, and 212 may have a thickness of 7.5 nm, for a total thickness of approximately 22 nm. However, each of the layers 202, 204, and 212 may have a different thickness.

In some embodiments, the layers 202, 204, and 212 are TiO₂ and the quantum emitter 110 is a trivalent Er³⁺ rare-earth ion. In these embodiments, the optical waveguide 104 may be fabricated from silicon. This silicon may be the handle layer of an SOI wafer. These advantages are particularly advantageous when the single photon 132 has a wavelength within, or near, the telecom C-band between 1530 and 1565 nm. In this band, silicon is highly transmissive. However, for other wavelengths, other types of materials may be used for the waveguide 104 (e.g., silicon nitride (SiN), lithium niobate (LiNbO₃), aluminum nitride (AlN), etc.). Similarly, the waveguide 104 and layers 202, 204, and 212 may be fabricated on a wafer of a different material (e.g., SiN, lithium nickel dioxide (LNO), etc.). Additional details about fabricating the layers 202, 204, and 212, especially for the case of Er ions embedded within TiO₂ thin films, can be found in Refs. [1-5] as well as International Publication WO 2023091546A1 and U.S. Patent Application Pub. No. 2022/0136133. Each of these publications is incorporated herein by reference in its entirety.

FIG. 3 is a top view of a single-photon source 300 that incorporates the single-photon source 100 of FIGS. 1 and 2 into a photonic integrated chip (PIC). The single-photon source 300 includes an input coupler 302 and an input waveguide 308 that guides the pump light 130 from the input coupler 302 to the single-photon source 100. The single-photon source 300 also includes an output coupler 304 and an output waveguide 310 that guides the single photon 132 from the single-photon source 100 to the output coupler 304. The input coupler 302, input waveguide 308, output waveguide 310, and output coupler 304 are fabricated on top of, or inside of, a top surface of the substrate 102, similar to the single-photon source 100.

The input coupler 302 connects to an input optical fiber 318 to form an input interconnect 312. Similarly, the output coupler 304 connects to an output optical fiber 328 to form an output interconnect 322. With the interconnects 312 and 322, the single-photon source 300 may be used with other optical components located “off-chip.” In the example of FIG. 3, the input coupler 302 is a surface grating coupler that uses diffraction to couple with the input optical fiber 318. The output coupler 304 is also shown as a surface grating coupler. Alternatively, each of the couplers 302 and 304 may be configured for end-fire coupling or adiabatic coupling. The optical fibers 318 and 328 may be conventional single-mode fiber (e.g., SMF-28), polarization-maintaining fiber, photonic crystal fiber, or another type of optical fiber known in the art.

In some embodiments, the single-photon source 300 is fabricated from cryogenic-compatible materials, which advantageously allows the single-photon source 300 to be placed in a cryogenic environment (e.g., temperatures as low as 10 mK, or less) while other optical components (e.g., a pump laser that generates the pump light 130) are located at room temperature outside of the cryogenic environment. In this case, the optical fibers 318 and 328 may be used to guide the pump light 130 and single photon 132, respectively, between these two environments. To ensure that the interconnects 312 and 322 are robust enough to survive cryogenic temperature cycling, the optical fibers 318 and 328 may be connected to the couplers 302 and 304 with photonic wire bonding, butt-coupling, or facet-attached microlenses.

In FIG. 3, the waveguides 308 and 310 are curved such that the couplers 302 and 304 are located along the same edge of the substrate 102. However, the waveguides 308 and 310 may be shaped differently. Accordingly, the couplers 302 and 304 may be located on different edges of the substrate 102. Although not shown in FIG. 3, the single-photon source 300 may include additional optical components incorporated into the substrate 102 without departing from the scope hereof. Examples of such optical components include, but are not limited to, resonators, filters, splitters/combiners, additional waveguides, and nonlinear optical elements. The single-photon source 300 may also include electronic elements incorporated within or on the substrate 102. Examples of such electronic components include, but are not limited to, microheaters, electrodes, wires (i.e., electrically conductive paths), and photodetectors.

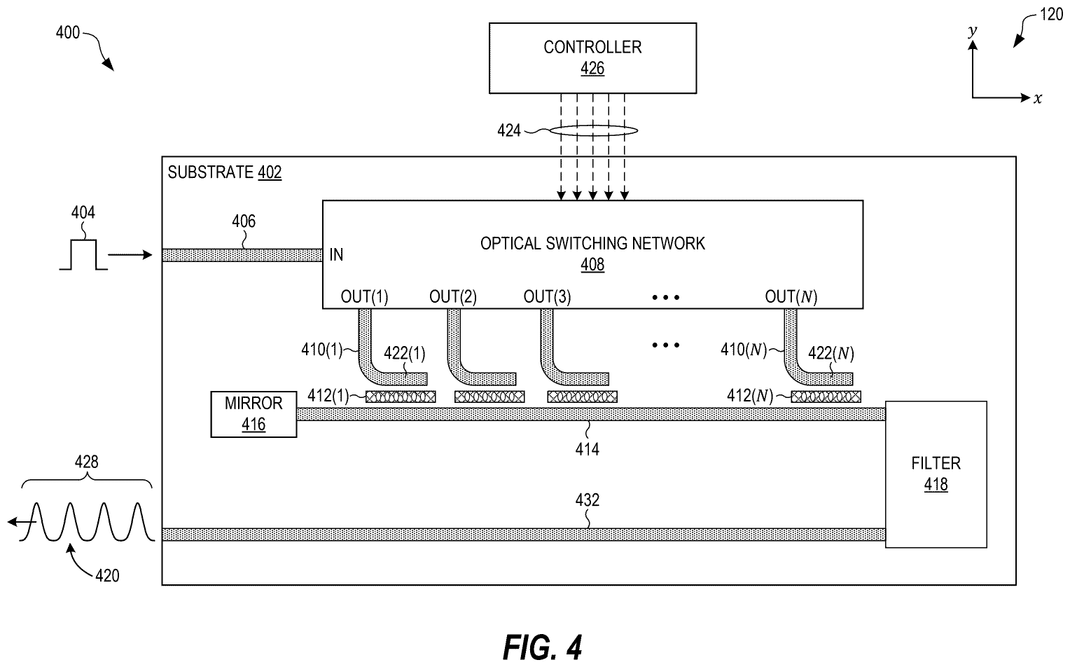

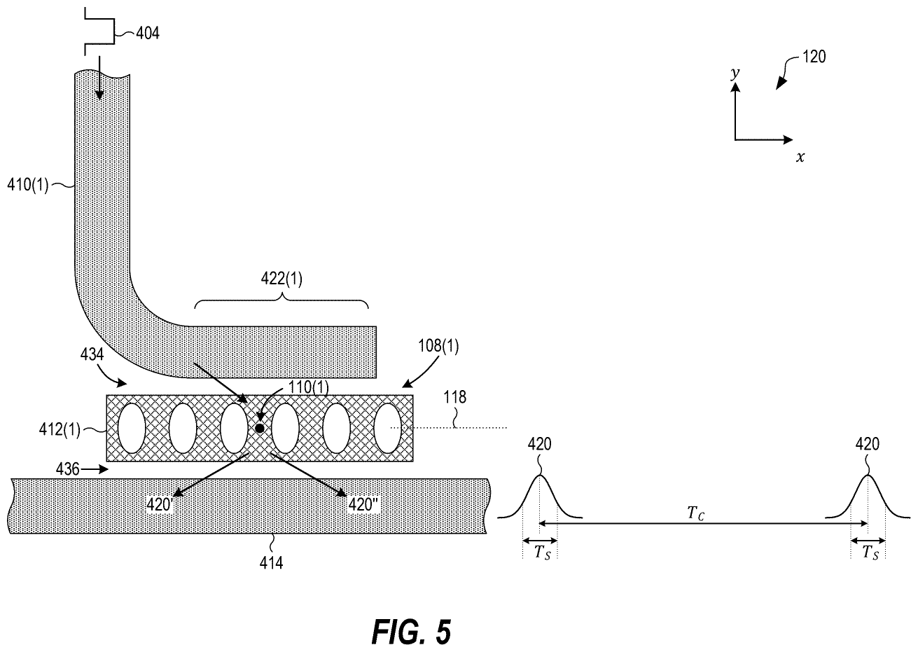

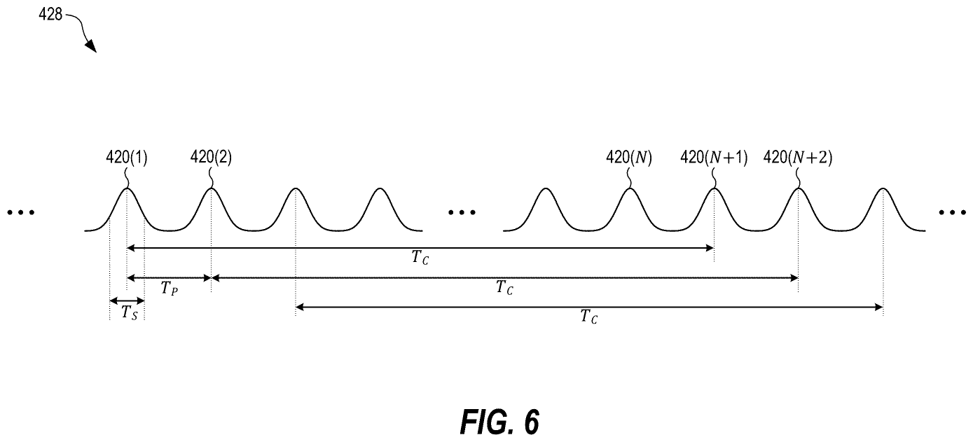

FIG. 4 is a top view of a time-multiplexed single-photon generator 400 that generates a photon stream 428 of single photons 420, in accordance with some of the present embodiments. The single-photon generator 400 includes N of the single-photon source 100 of FIG. 1, shown in FIG. 4 as a first single-photon sources 412(1) through an N^{th} single-photon source 412(N). FIG. 5 shows a more detailed view of the first single-photon source 412(1) of FIG. 4. FIG. 6 illustrates the photon stream 428 of FIG. 4 in more detail. FIGS. 4-6 are best viewed together with the following description.

The time-multiplexed single-photon generator 400 includes a 1:N optical switching network 408 and an input waveguide 406 that couples pump light 404 to an input port of the optical switching network 408 (labeled “IN” in FIG. 4). The optical switching network 408 has N output ports (labeled “OUT(1)” through “OUT(N)” in FIG. 4) that are respectively connected to N intermediate waveguides 410(1) through 410(N). A controller 426 electrically controls the optical switching network 408, via an electrical bus 424, to connect the input port to any one of the N output ports. For example, when the controller 426 controls the optical switching network 408 to connect the input port to the i^{th} output port, then the pump light 404 exits the optical switching network 408 via the i^{th} output port and propagates along the i^{th} intermediate waveguide 410(i). Here, i is an integer with a value between 1 and N, inclusive.

The N single-photon sources 412 are co-linear, i.e., they are aligned such that the optical axis 118 of each of the N photonic crystal cavities 108 coincides with the same line (which is parallel to x in FIGS. 4 and 5). To evanescently couple the pump light 404 into the single-photon sources 412, each intermediate waveguide 410(i) forms a curve, at the end of which is a linear segment 422(i) that runs parallel to the single-photon source 412(i). For example, FIG. 5 shows the first intermediate waveguide 410(1) forming a first linear segment 422(1) that runs parallel to a first photonic crystal cavity 108(1) of the first single-photon source 412(1). The linear segment 422(1) is displaced from the single-photon source 412(1) in the +y direction to form a gap 434 therebetween that is small enough that the pump light 404 can evanescently couple into the single-photon source 412(1). Specifically, the size of the gap 434 (along y) is comparable to or less than the wavelength λₚ of the pump light 404. Typically, the size of the gap 434 is in the range of 100-400 nm, with the size determining whether the photonic crystal cavity 108(1) is overcoupled, undercoupled, or critically coupled with the photonic crystal cavity 108(1). Furthermore, the length of the linear segment 422(1), along x, that is adjacent to the photonic crystal cavity 108(1) is much longer than λₚ, again to ensure that the pump light 404 can evanescently couple into the photonic crystal cavity 108(1). The geometry shown in FIG. 5 applies to all N of the linear segments 422 and single-photon sources 412 of FIG. 4.

The time-multiplexed single-photon generator 400 also includes a bus waveguide 414 that runs adjacent to the single-photon sources 412 and is displaced from the single-photon sources 412 in the −y direction. As shown in FIG. 5, a gap 436 between the bus waveguide 414 and the single-photon sources 412 is small enough that single photons 420 generated by any of the N single-photon sources 412 can evanescently couple into the bus waveguide 414. Specifically, the size of the gap 436 (along y) is comparable to or less than the wavelength λ_{S} of the single photons 420. Typically, the size of the gap 436 is in the range of 100-400 nm, with the size determining whether the photonic crystal cavity 108(1) of the single-photon source 412(1) is overcoupled, undercoupled, or critically coupled with the bus waveguide 414.

FIG. 5 shows how a first quantum emitter 110(1) of the first single-photon source 412(1) can emit either a single photon 420″ that propagates along the bus waveguide 414 in the +x direction or a single photon 420′ that propagates along the bus waveguide 414 in the −x direction. As shown in FIG. 4, the time-multiplexed single-photon generator 400 may also include a mirror 416 that is located at one end of the bus waveguide 414 and retroreflects the single photon 420′ such that it then propagates along the bus waveguide 414 in the +x direction. Thus, the mirror 416 ensures that all single photons emitted by all of the N single-photon sources 412 propagate along the bus waveguide 414 in the same direction. The mirror 416 may be a Bragg reflector, Sagnac loop, or another type of mirror or retroreflector known in the art.

The time-multiplexed single-photon generator 400 advantageously generates single photons 420 at a rate that is higher than what can be achieved using only one of the single-photon sources 412 (i.e., without time-multiplexing). For example, assume that all of the single photons 420 have the same temporal width T_{S}=1 μs and that the emission rate of single photons 420 from the first photonic crystal cavity 108(1) is T_{C}⁻¹=(10 μs)⁻¹=10 kHz, where T_{C} is the average emission time of single photons 420 from the photonic crystal cavity 108(1). In this case, there is, on average, about (T_{C}−T_{S})≈9 μs of “dead” time between two sequential single photons 420 emitted by the single-photon source 412(1). During this dead time, up to (T_{C}−T_{S})/T_{S}=9 additional single photons 420 can be generated and emitted without temporal overlap (as needed to ensure their indistinguishability). These additional single photons 420 can be generated with additional single-photon sources 412. To prevent temporal overlap, the maximum number N of single-photon sources 412 that can be used is approximately N≈T_{C}/T_{S}.

FIG. 6 illustrates one example of the photon stream 428 of FIG. 4. In this example, the single photons 420 all have the same temporal width T_{S} and wavelength. The first single-photon source 412(1) of FIG. 4 emits a first single photon 420(1), after which it is pumped again. During this pumping and subsequent decay, the second single-photon source 412(2) of FIG. 4 emits a second single photon 420(2) at a time T_{P} after the first single photon 420(1). After this emission, the second single-photon source 412(2) is pumped again. This process of spontaneous emission and pumping continues through all N single-photon sources 412, thereby extending the photon stream 428 to an N^{th} single photon 420(N) emitted by the N^{th} single-photon source 412(N). After time T_{C} has passed since the first single photon 420(1) was emitted, the first single-photon source 412(1) then emits another single photon 420(N+1). Single-photon generation then continues, as described, cyclically through the N single-photon sources 412(1) . . . 412(N) to generate single photons 420(N+2) through 420(2N), single photons 420(2N+1) through 420(3N), and so on.

Since spontaneous emission is a random process, the time at which a quantum emitter 110 emits a single photon is random. Similarly, the time at which a photonic crystal cavity 108 emits is also random. Accordingly, T_{P} and T_{C} are shown in FIG. 6 as average times. In practice, due to the random nature of the spontaneous emission, the spacing between single photons will vary and will likely not be periodic. For this reason, the sequence of single photons 420 is referred to as a “stream” instead of a “pulse train.”

To implement cyclical single-photon generation with the N single-photon sources 412, the controller 426 controls the optical switching network 408 to route the pump light 404 to each of the N single-photon sources 412 at the appropriate time. In one embodiment, the controller 426 controls the optical switching network 408 to output pump light 404 sequentially through the N output ports over the time T_{C}, thereby sequentially pumping the N single-photon sources 412 one-at-a-time. This control may be cyclical, i.e., pump light 404 is outputted from the first output port following pump light 404 outputted from the N^{th} output port.

The optical switching network 408 may be fabricated using any kind of active (i.e., electrically controlled) optical switch known in the art. Examples of such optical switches include, but are not limited to, Mach-Zehnder interferometers and ring switches. In another embodiment, a passive delay network is used for the optical switching network 408. In this embodiment, the pump light 404 is delayed (e.g., via an appropriate length of an optical waveguide or optical fiber) based on which of the N single-photon sources 412 it pumps.

The time-multiplexed single-photon generator 400 may include one or more additional components integrated with the substrate 402. For example, FIG. 4 shows the generator 400 with an optical filter 418 that spectrally filters the photon stream 428. The filter 418 may, for example, block residual pump light 404 that couples into the bus waveguide 414. The filter 418 may also be used to spectrally select single photons 420 lying within a certain spectral band. The filter 418 may be a microresonator, Mach-Zehnder interferometer, or other type of optical component that performs spectral filtering. In the example of FIG. 4, the photon stream 428 exits the filter 418 along an exit waveguide 432. Light rejected by the filter 418 may be coupled into an on-chip beam dump or another waveguide that guides the rejected light to an optical interconnect for dumping this rejected light off-chip. In another embodiment, the generator 400 excludes the filter 418, in which case the bus waveguide 414 and exit waveguide 432 are the same. In this embodiment, filtering may be performed off-chip (e.g., via a fiber-optic-based filter) or not at all.

Although not shown in FIG. 4, the time-multiplexed single-photon generator 400 may include the input coupler 302 of FIG. 3 to form the input interconnect 312. Additionally or alternatively, the generator 400 may include the output coupler 304 of FIG. 3 to form the output interconnect 322. Thus, the generator 400 may be used with optical fibers, such as to enable cryogenic operation and operation with additional external components (e.g., a pump laser).

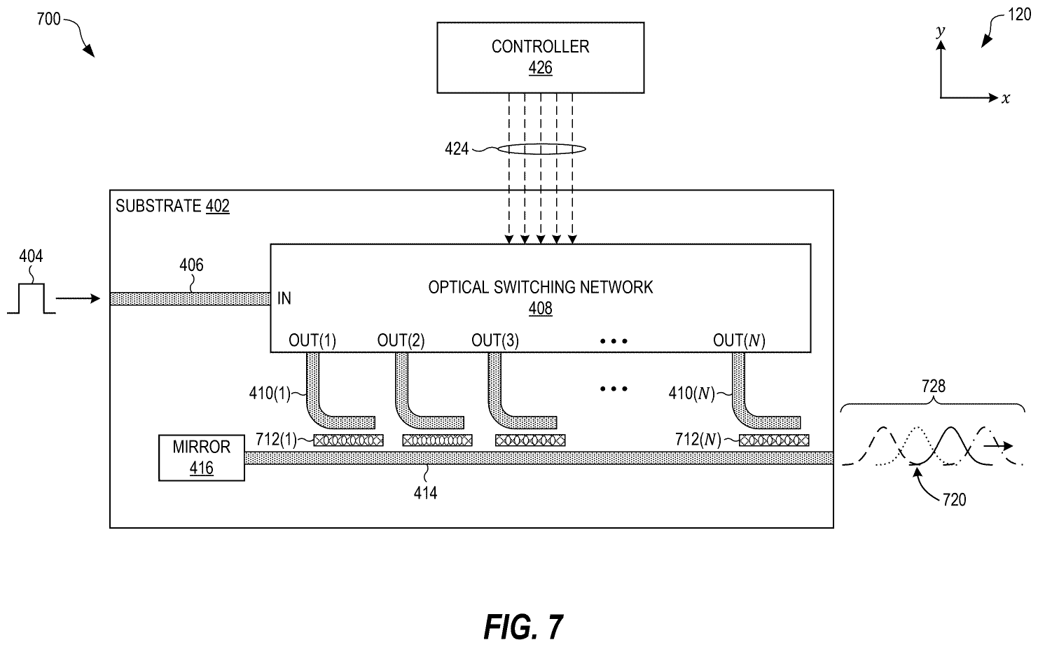

FIG. 7 is a top view of a frequency-multiplexed single-photon generator 700 that generates a photon stream 728 of single photons 720, in accordance with some of the present embodiments. The frequency-multiplexed single-photon generator 700 is similar to the time-multiplexed single-photon generator 400 of FIG. 4 except that it includes N single-photon sources 712 that are configured to emit single photons 720 at different frequencies. By contrast, the single-photon sources 412 of FIG. 4 are all configured to emit single photons 420 at the same frequency. The single-photon sources 712 may be configured to emit single photons at different frequencies using techniques described above (e.g., Stark-shift tuning via electrodes). Each of the single-photon sources 712 includes a photonic crystal cavity similar to the photonic crystal cavity 108 described above. As an alternative to Stark or Zeeman tuning (or in addition to these tuning mechanisms), the photonic crystal cavities of the single-photon sources 712 may be fabricated with different lattice constants so that they resonate at different frequencies.

Since single photons 720 emitted from different single-photon sources 712 are distinguishable based on frequency, it is not necessary that such single photons 720 be temporally distinguishable. Accordingly, the frequency-multiplexed single-photon generator 700 may be operated such that at least some of the single photons 720 are temporally overlapped, as shown in FIG. 7, and therefore the rate of the photon stream 728 can exceed the rate of the photon stream 428 of FIG. 4, even though only one of the single-photon sources 712 can be pumped at any given time. Such temporal overlap can be achieved because the time needed to pump any one of the single-photon sources 712 is short compared to its spontaneous lifetime. Once coupled off-chip, the single photons 720 can be demultiplexed or frequency converted to the same frequency.

While the above embodiments are shown implemented using PIC technology, it should be appreciated that each embodiment herein need not be implemented entirely as a PIC-based device fabricated on the substrate 402. For example, the optical switching network 408 can be constructed using fiber-optic switches and components. In this case, each of the output ports of the optical switching network 408 can be coupled to its respective intermediate waveguide 410(i) via an optical interconnect similar to the optical interconnects 312 and 322 shown in FIG. 3.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### REFERENCES

[1] C. Ji et al., “Nanocavity-mediated Purcell enhancement of Er in TiO₂ thin films grown via atomic layer deposition,” arXiv:2309.13490v1 (2023).
[2] A. M. Dibos et al., “Purcell Enhancement of Erbium Ions in TiO₂ on Silicon Nanocavities,” Nano Lett. 22, pp. 6530-6536 (2020).
[3] M. Raha, “A Telecom-Compatible Quantum Memory in the Solid-State: Single Erbium Ions Coupled to Silicon Nanophotonic Circuits,” Ph.D. thesis, Princeton University (2021).
[4] M. K. Singh et al., “Development of a Scalable Quantum Memory Platform—Materials Science of Erbium-Doped TiO₂ Thin Films on Silicon,” arXiv:2202.05376 (2022).
[5] S. E. Sullivan et al., “Quasi-deterministic Localization of Er Emitters in Thin Film TiO₂ through Submicron-scale Crystalline Phase Control,” arXiv:2308.14999v1 (2023).

What is claimed is:

1. A multiplexed single-photon generator, comprising:
a plurality of single-photon sources, each of the plurality of single-photon sources comprising an optical cavity and a quantum emitter coupled to the optical cavity;
an optical switching network controllable to couple pump light into the optical cavity of any one of the plurality of single-photon sources; and
a bus waveguide coupled to the optical cavity of each of the plurality of single-photon sources.

2. The multiplexed single-photon generator of claim 1, further comprising a retroreflector located at an end of the bus waveguide.

3. The multiplexed single-photon generator of claim 1, further comprising an optical filter coupled to the bus waveguide and configured to couple unabsorbed pump light out of the bus waveguide.

4. The multiplexed single-photon generator of claim 1, the optical cavity comprising a photonic crystal cavity.

5. The multiplexed single-photon generator of claim 1, the optical cavity being evanescently coupled to the bus waveguide.

6. The multiplexed single-photon generator of claim 1, wherein:
the optical switching network comprises a plurality of output ports; and
each of the plurality of output ports is evanescently coupled to the optical cavity of a respective one of the plurality of single-photon sources.

7. The multiplexed single-photon generator of claim 1, wherein:
the quantum emitter of each of the plurality of single-photon sources, in response to being pumped by the pump light, spontaneously decays to emit a single photon having a respective one of a plurality of center frequencies; and
all of the plurality of center frequencies are the same.

8. The multiplexed single-photon generator of claim 1, wherein:
the quantum emitter of each of the plurality of single-photon sources, in response to being pumped by the pump light, spontaneously decays to emit a single photon having a respective one of a plurality of center frequencies; and
at least two of the plurality of center frequencies differ from each other.

9. The multiplexed single-photon generator of claim 1,
further comprising a substrate;
wherein the plurality of single-photon sources and the bus waveguide are located on or within the substrate.

10. The multiplexed single-photon generator of claim 9, the substrate comprising silicon-on-insulator, lithium niobate, silicon nitride, aluminum nitride, strontium titanate, or any combination thereof.

11. The multiplexed single-photon generator of claim 1, the quantum emitter comprising a thin film of a solid-state material doped with one or more rare-earth ions.

12. The multiplexed single-photon generator of claim 11, the one or more rare-earth ions comprising a plurality of rare-earth ions having a density of 1 ppm or less.

13. The multiplexed single-photon generator of claim 11, each of the one or more rare-earth ions being an erbium ion, a praseodymium ion, a neodymium ion, a ytterbium ion, or a europium ion.

14. The multiplexed single-photon generator of claim 11, the solid-state material comprising titanium dioxide (TiO₂), calcium tungstate (CaWO₄), yttrium orthosilicate (Y₂SiO₅), yttrium orthovanadate (YVO₄), yttrium aluminum garnet (Y₃Al₅O₁₂), or any combination thereof.

15. A method for single-photon generation, comprising:
coupling a first pump pulse into the optical switching network of the multiplexed single-photon generator of claim 1;
controlling the optical switching network to couple the first pump pulse into the optical cavity of a first single-photon source of the plurality of single-photon sources of the multiplexed single-photon generator;
coupling a first single photon emitted by the quantum emitter of the first single-photon source into the first optical cavity; and
coupling the first single photon from the first optical cavity into the bus waveguide of the multiplexed single-photon generator.

16. The method of claim 15, further comprising:
coupling a second pump pulse into the optical switching network;
controlling the optical switching network to couple the second pump pulse into a second single-photon source of the plurality of single-photon sources, the second single-photon source being different from the first single-photon source;
coupling a second single photon emitted by the quantum emitter of the second single-photon source into a second optical cavity of the second single-photon source; and
coupling the second single photon from the second optical cavity into the bus waveguide.

17. The method of claim 16, wherein said coupling the second pump pulse occurs such that a temporal duration between the first single photon and the second single photon is greater than one or both of a first temporal width of the first single photon and a second temporal width of the second temporal width.

18. The method of claim 16, wherein said coupling the second pump pulse occurs such that a temporal duration between the first single photon and the second single photon is less than one or both of a first temporal width of the first single photon and a second temporal width of the second temporal width.

19. The method of claim 16, wherein:
the first single photon has a first center frequency; and
the second single photon has a second center frequency different from the first center frequency.

20. The method of claim 19, further comprising frequency demultiplexing the first single photon and the second single photon.
